(19) United States
(12) Patent Application Publication
(10) Pub. No.: US 2008/0148185 A1
(43) Pub. Date: Jun. 19, 2008

(54) Item Editing Device, Item Editing Method, And Program

(75) Inventors: Masakazu Honma, Nagano-ken (JP); Junichi Otsuka, Nagano-ken (JP)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(73) Assignee: SEIKO EPSON CORPORATION, Tokyo (JP)

(21) Appl. No.: 11/955,938

(22) Filed: Dec. 13, 2007

(30) Foreign Application Priority Data
Dec. 19, 2006 (JP) 2006340860

(51) Int. Cl. G06F 3/048

(52) U.S. Cl. 715/825

(57) ABSTRACT

An item editing device, an item editing method, and a program enable batch changing attribute information for a plurality of items that are laid out in the layout area without producing a result that is visually discordant to the user. The label editing unit 27 has an oriented item determination unit 41, a batch changing unit 42, an item layout unit 43, and a item data storage unit 44, and enables batch changing attribute information for a plurality of items that are laid out in the layout area without producing a result that is visually discordant to the user regardless of the angle of rotation or type of the item. The user can therefore batch change a plurality of items without visually discordant results.

### CROSS-REFERENCE TO RELATED APPLICATIONS

Japanese Patent application No. 2006-340860 is hereby incorporated by reference in its entirety.

### BACKGROUND

1. Field of Invention

The present invention relates to an item editing device, an item editing method, and a program.

More particularly, the invention relates to an item editing device, an item editing method, and a program enabling batch changing attribute information for a plurality of items arranged in a layout area in a way that is not visually discordant to the user.

2. Description of the Related Art

Demand has risen for centrally managing recording data on optical recording media such as CDs and DVDs in order to ensure the confidentiality of personal information and corporate secrets, for example. Demand for producing or dubbing relatively small quantities, such as approximately 10 to 100, optical recording media for distribution at trade shows or on the street is also growing.

To meet these needs, disc-publishing devices that record digital data, image data, or music data, for example, at high speed on optical recording media and then print the disc content on the label surface have been introduced.

An example of a recording medium production device for business applications is the recording medium production device taught in Japanese Unexamined Patent Appl. Pub. JP-A-2002-58649 that has a disc holder for stocking blank CDs, a CD recording unit, a label printer unit, and a recorded CD holder, and is used for recording medical images on optical recording media and printing an identification label on the label side.

When a batch or group of items such as text strings, pictures, and figures are laid out on the printing surface (label surface) of a CD or DVD, for example, attribute information for plural items may be changed in a single operation for a batch of items. See, for example, Japanese Unexamined Patent Appl. Pub. JP-A-2000-58649.

When attribute information is batch changed for a group of items and the change is applied by the conventional method based on the attributes of a target item, which is the item that is manipulated to change the attribute information, to the attributes of the other items in the same batch (referred to below as “grouped items”), the attributes of the grouped items may not be changed as intended by the user. More specifically, the batch change produces a result that is visually discordant to the user. For example, when the width (horizontal dimension) of the target item is changed, the height (vertical dimension) of a grouped item that is rotated 90° to the target item will be changed.

FIG. 7 shows what happens when the width of a plurality of items is batch changed by the conventional method. The target item 81 and the grouped item 82 in this example are rectangular items without defined horizontal and vertical directions. As shown in FIG. 7, changing the width 83 of the target item 81 in the horizontal direction (width-changing direction) results in changing the height 84 of the grouped item 82 that is rotated 90°.

When manipulating a plurality of items that do not have defined vertical and horizontal directions (“un-oriented items” below) in a single batch, and when changing un-oriented items and items with defined vertical and horizontal directions (“oriented items” below) together in the same batch, item attributes are changed without considering the orientation of each item, and the items are not changed as intended by the user.

### SUMMARY OF THE INVENTION

The item editing device, the item editing method, and the program of the invention enable batch changing attribute information for a plurality of items that are laid out in the layout area without producing a result that is visually discordant to the user.

A first aspect of the invention is an item editing device for editing a plurality of items arranged in a layout area, the item editing device including: an oriented item determination unit that determines for each selected item in a group of plural selected items that are selected from among the items arranged in the layout area whether the item is an oriented item with specific vertical and horizontal axes, or an un-oriented item without specific vertical and horizontal axes; a batch changing unit that changes the attribute information for all selected items based on the orientation of each selected item determined by the oriented item determination unit; and an item layout unit that rearranges all selected items in the layout area based on the attribute information of the selected items after being changed by the batch changing unit.

Regardless of the angle of rotation or type of item, this aspect of the invention enables batch changing attribute information for a plurality of items that are arranged in a layout area without producing a result that is visually discordant to the user. In other words, the user can batch change the attributes of plural items so that the changed items are not visually discordant. The user can therefore efficiently manipulate and edit items. The attribute information as used herein includes, for example, the item width, height, angle of rotation, position, and display attributes.

In an item editing device according to another aspect of the invention, the batch changing unit has an orientation determination unit for determining the width-change direction and the height-change direction of each selected item based on prescribed rules when the attribute that is changed is the width or the height; a target item attribute changing unit that changes the attribute information of the target item; and a grouped item attribute changing unit that changes the attribute information for each grouped item based on the before and after values of the attribute information of the target item that are changed by the target item attribute changing unit, the grouped items being the selected items other than the target item.

Further preferably, when the attribute that is changed is the width or the height, the grouped item attribute changing unit changes the attribute information of the grouped items based on the before and after attribute values, the width-change direction, and the height-change direction of the target item, and the width-change direction, the height-change direction, and the attribute information of the grouped item before the attribute information is changed.

When batch changing the width or height of an item, this aspect of the invention enables the user to edit attributes without visually discordant results.

In an item editing device according to another aspect of the invention, when the attribute that is changed is the width or height, the grouped item attribute changing unit changes the attribute information of the grouped item so that after the attribute information is changed the amount of change in the attribute information of the target item is equal to the amount of change in the attribute information of the grouped item. When the attribute that is changed is the angle of rotation or position, the grouped item attribute changing unit changes the attribute information of the grouped item so that after the attribute information is changed the amount of change in the attribute information of the target item and the amount of change in the attribute information of the grouped item are the same. When the attribute that is changed is a display attribute, the grouped item attribute changing unit changes the attribute information of the grouped item so that after the attribute information is changed the attribute value of the target item and the attribute value of the grouped item are the same.

When batch changing the width, height, angle of rotation, position, or display attribute of an item, this aspect of the invention enables the user to edit attributes without visually discordant results.

In the item editing device according to another aspect of the invention, the prescribed rule is defined as follows where a positive angle α is predefined.

When the selected item is an un-oriented item, movement of a side perpendicular to a line at angle of rotation θ is the width-change direction of the item, and movement of a side parallel to the line at angle of rotation θ is the height-change direction of the item, if the angle of rotation θ of the selected item is

0°≦θ<α, or

(180°−α)≦θ<(180°+α), or

(360°−α)≦θ<360°, and

if the angle of rotation θ of the selected item is

α≦θ<(180°−α), or

(180°+α)≦θ<(360°−α),

movement of a side perpendicular to a line at angle of rotation θ is the height-change direction of the item, and movement of a side parallel to the line at angle of rotation θ is the width-change direction of the item.

When the selected item is an oriented item, the horizontal direction when the selected item is reset to θ=0° is the width-change direction and the vertical direction when the selected item is reset to θ=0° is the height-change direction regardless of the angle of rotation θ of the selected item.

This aspect of the invention enables the user to change attribute information without visually discordant results even if the item is set to a non-zero angle of rotation. If angle α is 45°, the user can change attribute information with even less visually discordant results.

Another aspect of the invention is an item editing method for editing a plurality of items arranged in a layout area, including: (a) an oriented item determination step that determines for each selected item in a group of plural selected items that are selected from among the items arranged in the layout area whether the item is an oriented item with specific vertical and horizontal axes, or an un-oriented item without specific vertical and horizontal axes; (b) a batch changing step that changes the attribute information for all selected items based on the orientation of each selected item determined by the (a) oriented item determination step; and (c) an item layout step that rearranges all selected items in the layout area based on the attribute information of the selected items after being changed by the (b) batch changing step.

This aspect of the invention achieves the same effect as the item editing device described above.

In an item editing method according to another aspect of the invention the (b) batch changing step includes: (d) an orientation determination step for determining the width-change direction and the height-change direction of each selected item based on prescribed rules when the attribute that is changed is the width or the height; (e) a target item attribute changing step that changes the attribute information of the target item; and (f) a grouped item attribute changing step that changes the attribute information for each grouped item based on the before and after values of the attribute information of the target item that are changed by the target item attribute changing unit, the grouped items being the selected items other than the target item.

Further preferably, when the attribute that is changed is the width or the height, the (f) grouped item attribute changing step changes the attribute information of the grouped items based on the before and after attribute values, the width-change direction, and the height-change direction of the target item, and the width-change direction, the height-change direction, and the attribute information of the grouped item before the attribute information is changed.

This aspect of the invention achieves the same effect as the item editing device described above.

In an item editing method according to another aspect of the invention when the attribute that is changed is the width or height, the (f) grouped item attribute changing step changes the attribute information of the grouped item so that after the attribute information is changed the amount of change in the attribute information of the target item is equal to the amount of change in the attribute information of the grouped item.

When the attribute that is changed is the angle of rotation or position, the (f) grouped item attribute changing step changes the attribute information of the grouped item so that after the attribute information is changed the amount of change in the attribute information of the target item and the amount of change in the attribute information of the grouped item are the same.

When the attribute that is changed is a display attribute, the (f) grouped item attribute changing step changes the attribute information of the grouped item so that after the attribute information is changed the attribute value of the target item and the attribute value of the grouped item are the same.

This aspect of the invention achieves the same effect as the item editing device described above.

In an item editing method according to another aspect of the invention the prescribed rule is defined as follows where a positive angle α is predefined.

When the selected item is an un-oriented item, movement of a side perpendicular to a line at angle of rotation θ is the width-change direction of the item, and movement of a side parallel to the line at angle of rotation θ is the height-change direction of the item, if the angle of rotation θ of the selected item is

0°≦θ<α, or

(180°−α)≦θ<(180°+α), or

(360°−α)≦θ<360°, and

if the angle of rotation θ of the selected item is

α≦θ<(180°−α), or

(180°+α)≦θ<(360°−α),

movement of a side perpendicular to a line at angle of rotation θ is the height-change direction of the item, and movement of a side parallel to the line at angle of rotation θ is the width-change direction of the item.

When the selected item is an oriented item, the horizontal direction when the selected item is reset to θ=0° is the width-change direction and the vertical direction when the selected item is reset to θ=0° is the height-change direction regardless of the angle of rotation θ of the selected item.

This aspect of the invention achieves the same effect as the item editing device described above.

Another aspect of the invention is a tangible computer-readable medium embodying program instructions executable by a computer, the media including instructions for performing the item editing methods described above. With this aspect of the invention the computer reads the program and executes the process defined by the program, and thus achieves the same effect as the item editing device described above.

A user can thus batch change attribute information for a plurality of items that are laid out in a layout area without producing a result that is visually discordant to the user irrespective of the type or angle of rotation of any item.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows a recording medium production control device 10 having a label editing unit 27 according to the present invention and a recording medium production device 90 that is controlled by the recording medium production control device 10.

FIG. 2 is a function block diagram of a preferred embodiment of the label editing unit 27.

FIG. 3 shows the width direction and the height direction of an un-oriented item.

FIG. 4 shows the width direction and the height direction of an oriented item.

FIG. 5 shows the batch changing operation when the target item is an un-oriented item.

FIG. 6 shows the batch changing operation when the target item is an oriented item.

FIG. 7 shows batch changing the width of a plurality of items by the method of the related art.

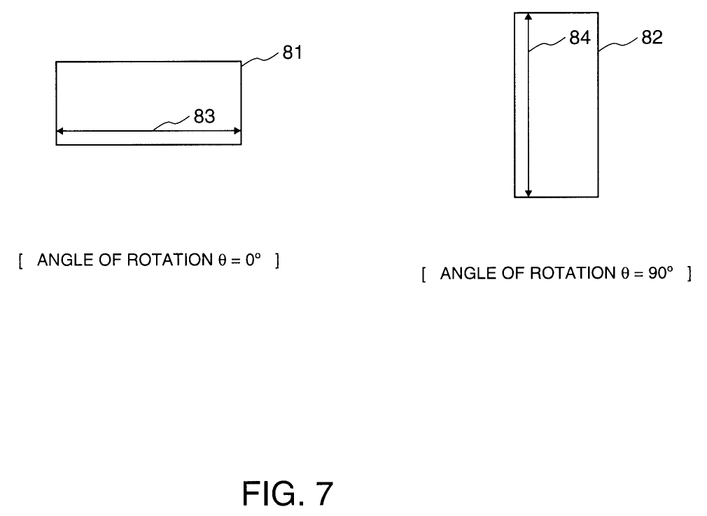

### DESCRIPTION OF THE PREFERRED EMBODIMENTS

Preferred embodiments of the present invention are described below with reference to the accompanying figures. These embodiments are described by way of example only and do not limit the scope of the invention. It will be obvious to one with ordinary skill in the related art that some or all of the elements described below can be replaced with similar or equivalent elements, and all such variations are also included in the scope of the invention.

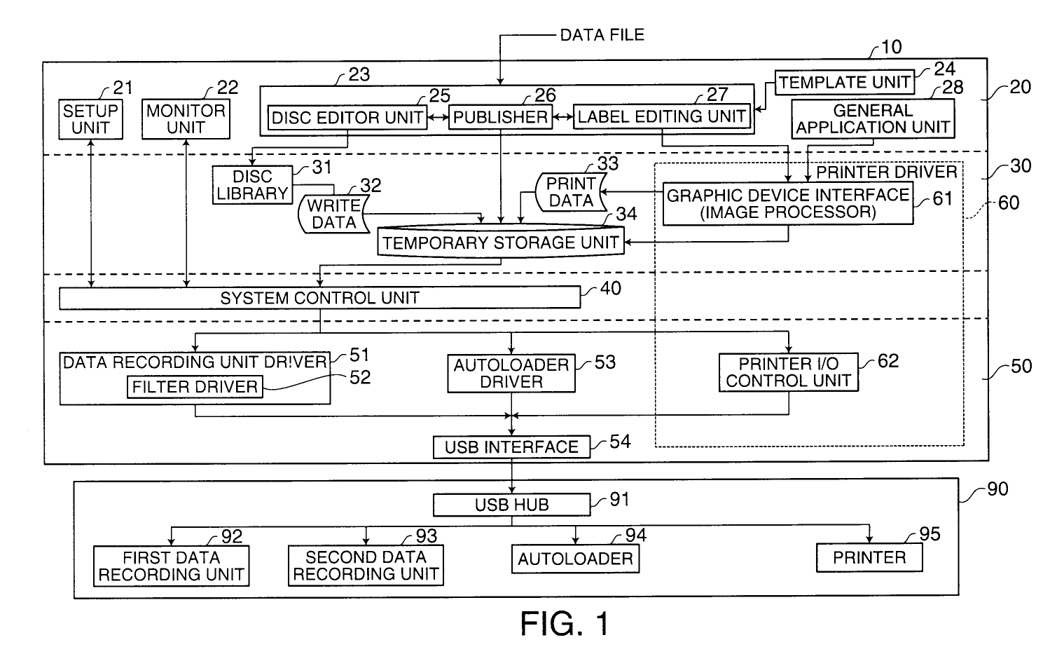

FIG. 1 shows a recording medium production control device 10 having a label editing unit 27 according to the present invention and a recording medium production device 90 that is controlled by the recording medium production control device 10.

In FIG. 1 the recording medium production control device 10 may be embodied in a personal computer (PC), server, or other host device and installed software.

The PC or other host device typically includes hardware such as a CPU, memory such as RAM or ROM, and logic circuits, and software, and can run a general purpose operating system such as Windows (R).

The recording medium production control device 10 is described in terms of functional blocks. The recording medium production control device 10 includes an application unit 20, a data conversion unit 30, a system control unit 40, and a device control unit 50.

The application unit 20 provides the basic functions for producing optical recording media, and the data conversion unit 30 generates and temporarily stores the write data, print data, and production settings according to data received from the application unit 20. The system control unit 40 schedules the sequence of operating processes for producing optical recording media based on control signals from the data conversion unit 30, and controls the operating sequence of the drivers in the device control unit 50. The device control unit 50 includes a USB interface 54 and various drivers for controlling the operation of the recording medium production device 90.

The write data is the information that is written on the optical recording medium. The print data is the information that is printed on the label surface of the optical recording medium. The production settings are information defining the type of command request (any one of a write and print request, a write request, and a print request), the number of optical recording media to produce, and the type, for example.

The recording medium production device 90 includes a USB hub 91 and connected devices such as a first data recording unit 92, a second data recording unit 93, an autoloader 94 for carrying the optical recording media to different parts inside the recording medium production device 90, and a printer 95. The recording media production device can write to two optical recording media simultaneously.

While two data recording units and one printer are shown in FIG. 1, more data recording units and printers can be provided to enable parallel processing of more media.

When a write and print request is executed the printer 95 prints after writing data to the first data recording unit 92 or second data recording unit 93. The first data recording unit 92 or the second data recording unit 93 could have data written to it after the printer 95 finishes printing, but errors in the data writing process are more important and occur more frequently than errors in the printing process, and executing the data writing process first is therefore preferable.

The optical recording media production procedure will be described after briefly describing the functions of the recording medium production control device 10.

The application unit 20 provides a user interface for specifying the data file storing the desired write data and for configuring the print content and format.

In the embodiment shown in FIG. 1 the setup unit 21 provides a function for setting the initial configuration of the recording medium production device 90 (information directed to specific parts of the recording medium production device 90), and the monitor unit 22 provides a function for displaying and confirming the device status information describing the operating status of the various parts of the recording medium production device 90.

The disc production unit 23 has a disc editor unit 25, a publisher 26, and a label editor unit 27, and is used for editing the recording content, editing the production settings, and editing the label. The label can be edited using templates stored in a template unit 24.

The general application unit 28 provides functions different from the disc production unit 23, which handles print requests for the label surface.

The item editing device according to this embodiment of the invention corresponds to the label editing unit 27.

The content edited by the application unit 20 is output to the data conversion unit 30, and the write data 32 generated by the disc library 31 and the print data 33 generated by the graphic device interface 61 (GDI) of the printer driver 60 (printing control unit) is temporarily stored in the temporary storage unit 34 until the requested job is completed based on the type of the command request.

The system control unit 40 controls the operating procedure of the different devices in order to execute the job request stored in the temporary storage unit 34.

The system control unit 40 plans the operating procedure of the devices 92 to 95 that execute the job requests stored in the temporary storage unit 34, and generates an operating schedule describing the operating procedure.

The system control unit 40 also controls the operation of the devices 92 to 95 via the device control unit 50 based on the device status information describing the operating status acquired from the devices 92 to 95 through the device control unit 50, and the operating schedule.

More specifically, the system control unit 40 outputs the operating commands for the devices 92 to 95 to the data recording unit driver 51, the auto loader driver 53, and the print I/O control unit 62 based on the device status information and the operating schedule. The data recording unit driver 51, the auto loader driver 53, and the print I/O control unit 62 of the printer driver 60 then control the operation of the devices 92 to 95.

This enables controlling the devices 92 to 95 to pick up a blank optical recording medium for each job request, convey, write on, and print on the optical recording medium, and transport the recorded optical recording medium without the devices 92 to 95 interfering with each other. When producing multiple optical recording media, this arrangement also enables efficiently processing the media without the different devices interfering with each other.

The data recording unit driver 51 includes a filter driver 52 that selects only operating commands from the system control unit 40 as valid commands, and suppresses accepting operating commands for the first data recording unit 92 and the second data recording unit 93 from any source other than the system control unit 40. More specifically, the filter driver 52 allows control of the first data recording unit 92 or the second data recording unit 93 based on requests from a specific application, and suppresses requests from other applications so that those other applications cannot control the first data recording unit 92 or second data recording unit 93.

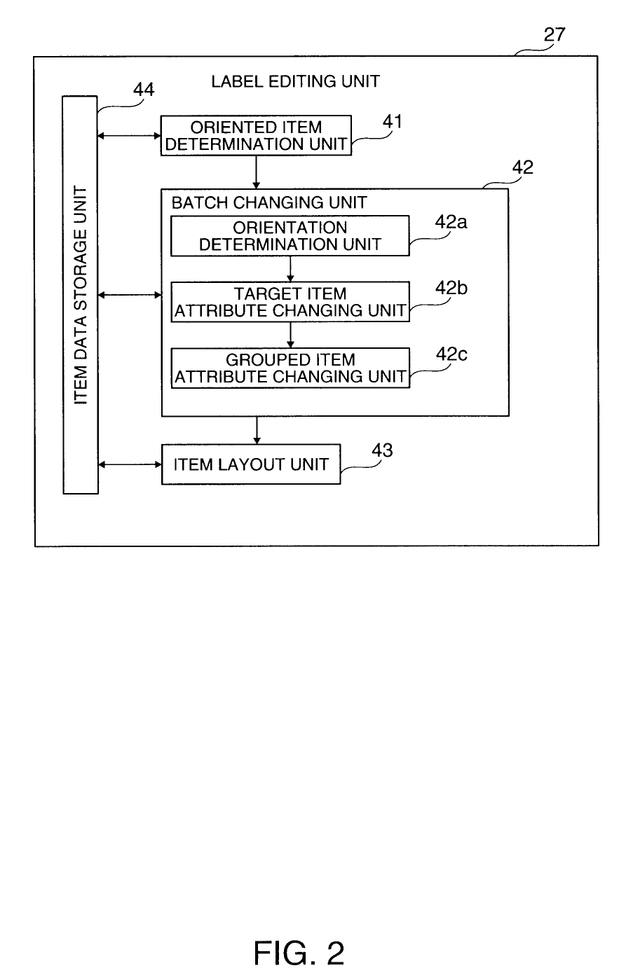

An item editing device according to the present invention is described next with reference to FIG. 2 to FIG. 6. FIG. 2 is a function block diagram of a preferred embodiment of the label editing unit 27. Only the functions of the parts related to the invention are shown in FIG. 2. The label editing unit 27 has an oriented item determination unit 41, a batch conversion unit 42, an item layout unit 43, and an item data storage unit 44.

For each of the plural selected items that were selected from among all of the items in the layout area for changing the attributes in a batch, the oriented item determination unit 41 determines if the item has a set orientation. For example, picture items and text items are items with a particular orientation (“oriented items” below), but rectangles, circles, and other geometric figures and line segments are items without a particular orientation (“un-oriented items”).

This determination is made based on directional orientation determination rules that are predefined for determining, based on the item type, if the item has a particular vertical or horizontal orientation. The results of this determination are stored in the item data storage unit 44 for each item.

For oriented items having vertical and horizontal directions, the vertical direction when the angle of rotation θ=0° is the height direction of the item, and the horizontal direction when θ=0° is the width direction of the item. The width and height axes of oriented items can therefore be determined even when the item is rotated to an angle of rotation θ from the reference position. It is therefore not necessary to consider the angle of rotation for oriented items.

For un-oriented items without specific vertical and horizontal directions, the vertical direction when seen on a screen is the height direction of the item and the horizontal direction is the width direction of the item. When an un-oriented item is rotated to an angle of rotation θ from the reference position, the width and height axes of the un-oriented item can be determined from the angle of rotation θ. It is therefore necessary to consider the angle of rotation for un-oriented items.

When the operation changing the attributes of the target item that is selected from among the selected items for changing the attributes is executed, the batch changing unit 42 changes the attributes of the grouped items, which are the selected items other than the target item, based on the directional orientation determined by the oriented item determination unit 41 for each of the selected items. This operation changes the same attribute as the attribute of the target item that was changed. For example, if the width of the target item is increased, the width of the grouped items is also increased. If the target item is rotated, the grouped items are also rotated. The changed attribute information is also stored in the item data storage unit 44 for each item.

The batch changing unit 42 has an orientation determination unit 42a, a target item attribute changing unit 42b, and a grouped item attribute changing unit 42c. When the attribute information that is changed is the width or the height, the orientation determination unit 42a determines the width direction and the height direction for each of the selected items based on the width/height determination rules. Exemplary (preferred embodiments) width/height determination rules are described next.

Exemplary Width/Height Determination Rules

When the selected item is an un-oriented item and the angle of rotation θ of the selected item is

0°≦θ<α, or

(180°−α)≦θ<(180°+α), or

(360°−α)≦θ<360°

the horizontal direction when θ=0° is the width-change direction of the selected item, and the vertical direction when θ=0° is the height-change direction of the selected item.

When the selected item is an un-oriented item and the angle of rotation θ of the selected item is

α≦θ<(180°−α), or

(180°+α)≦θ<(360°−α),

the horizontal direction when θ=0° is the height-change direction of the selected item, and the vertical direction when θ=0° is the width-change direction of the selected item.

When the selected item is an oriented item, the horizontal direction when θ=0° is the width-change direction of the selected item and the vertical direction when θ=0° is the height-change direction of the selected item regardless of the angle of rotation θ of the selected item. In this case α>0°, but preferably α=45°.

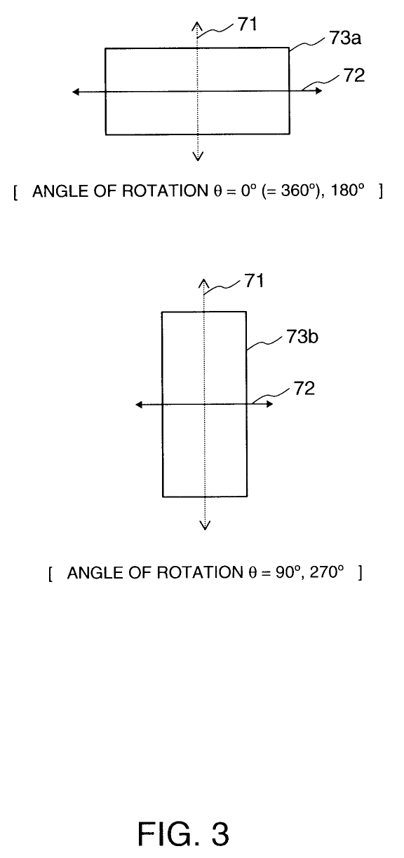

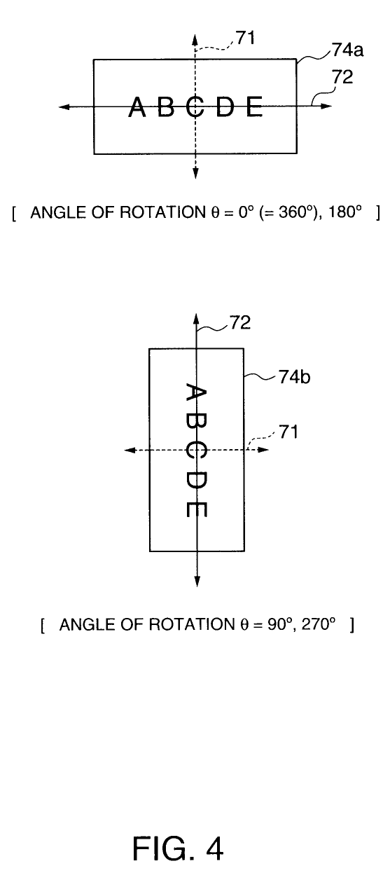

The width direction and height direction of an item are described next with reference to FIG. 3 and FIG. 4. FIG. 3 shows the width and height directions of an un-oriented item. FIG. 4 shows the width and height directions of an oriented item. In both examples α=45°.

As shown in FIG. 3, the width direction 72 of the un-oriented item 73a when θ=0° (=360°) and when θ=180° is parallel to the long side of the rectangle, and the height direction 71 of the item 73a is parallel to the short side of the rectangle. The width direction 72 of the item 73b when θ=90° and when θ=270° is parallel to the short side of the rectangle, and the height direction 71 of the item 73b is parallel to the long side of the rectangle. The width direction 72 and the height direction 71 of the un-oriented item thus change when the angle of rotation θ changes. As a result, if the width of this item is increased when θ=0° (=360°) or when θ=180°, the long side becomes longer, and if the width of this item is increased when θ=90° or when θ=270°, the short side becomes longer.

As shown in FIG. 4, the width direction 72 of the oriented item 74a when θ=0° (=360°) and when θ=180° is parallel to the long side of the rectangle, and the height direction 71 of the item 74a is parallel to the short side of the rectangle. When θ=90° and when θ=270°, the width direction 72 of the item 74b is still parallel to the long side of the rectangle and the height direction 71 of the item 74b is parallel to the short side of the rectangle. As a result, if the width of this item is increased, the long side becomes longer.

The target item attribute changing unit 42b in FIG. 2 changes the attribute information of the target item. The grouped item attribute changing unit 42c changes the attribute information of the grouped items based on the before and after values of the attribute information that is changed by the target item attribute changing unit 42b. For example, if the attribute that is changed is the width (or height), the width (or height) of the grouped items after the changes are applied is determined based on the before and after width (or height) of the target item, the ratio between the before and after width (or height), the orientation of the width direction and height direction of the target item, the before and after width (or height) of the grouped item, and the orientation of the width direction and height direction of the grouped item.

For example, if the attribute information is the angle of rotation (or position), the angle of rotation (or position) of the grouped item after the attribute is changed is determined based on the difference between the before and after angles of rotation (or position) of the target item and the angle of rotation (or position) of the grouped item before the change. If the attribute information is a display attribute, the display attribute of the grouped item is set to the display attribute of the target item.

Based on the attribute information of the selected item changed by the batch changing unit 42, the item layout unit 43 rearranges all of the selected items in the layout area.

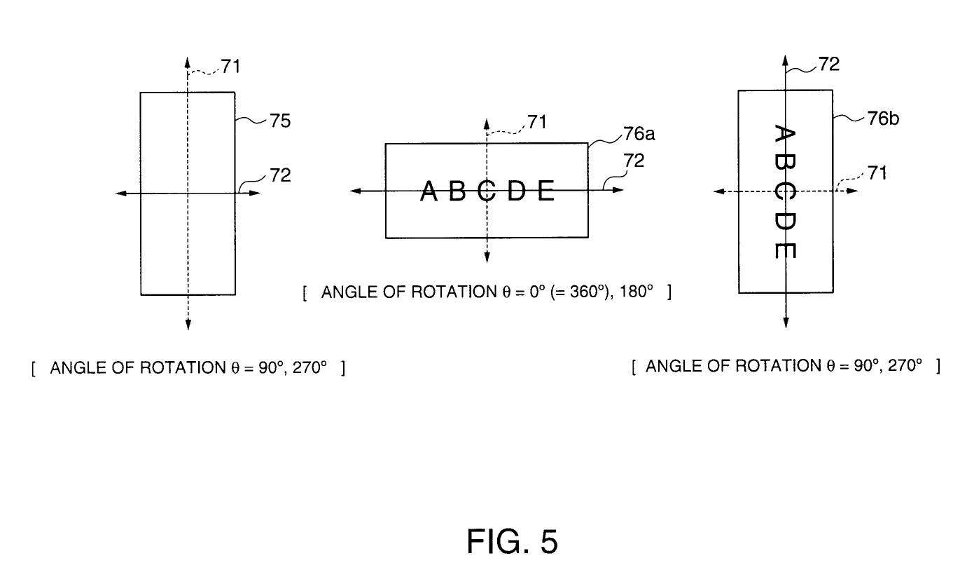

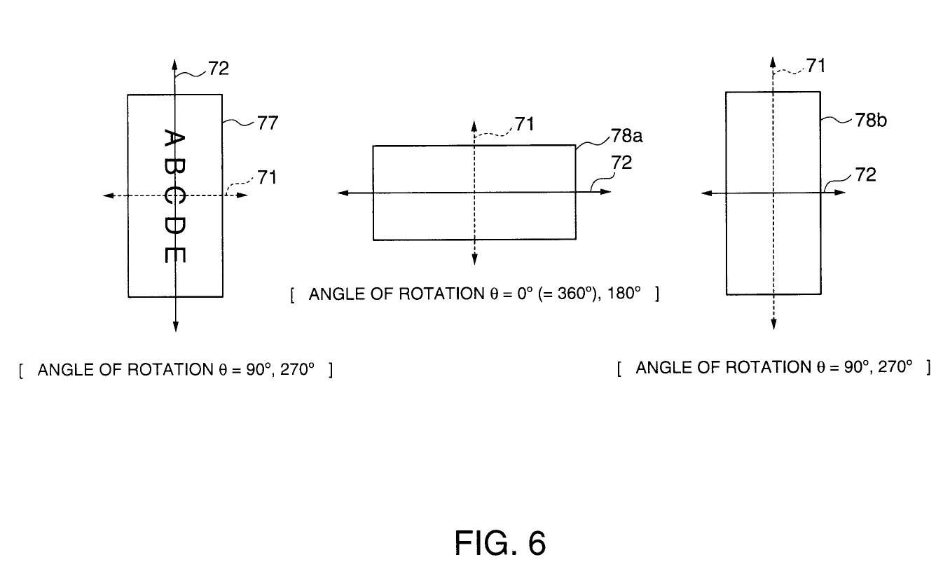

Batch changing the attribute information for a plurality of items is described next with reference to FIG. 5 and FIG. 6. FIG. 5 describes the batch changing operation when the target item is an un-oriented item. FIG. 6 describes the batch changing operation when the target item is an oriented item.

FIG. 5 illustrates a case in which the target item 75 is an un-oriented item and the grouped items 76a and 76b are oriented items, and the width direction or the height direction is changed for all items in the group (batch). In this example the angle of rotation θ of the target item 75 is 90°, the angle of rotation θ of the grouped item 76a is 0°, and the angle of rotation θ of the grouped item 76b is 90°. Also shown in the figure are the width direction 72 and the height direction 71 of each item. When the width of the target item 75, which is the short side of the target item 75, is increased, the width, that is, the long side, of the grouped items 76a and 76b is also increased.

FIG. 6 illustrates a case in which the target item 77 is an oriented item and the grouped items 78a and 78b are un-oriented items, and the width direction or the height direction is changed for all items in the group (batch). In this example the angle of rotation θ of the target item 77 is 90°, the angle of rotation θ of the grouped item 78a is 0°, and the angle of rotation θ of the grouped item 78b is 90°. Also shown in the figure are the width direction 72 and the height direction 71 of each item. When the width of the target item 77, which is the long side of the target item 77, is increased, the width (long side) of the grouped item 78a is increased and the width (short side) of grouped item 78b is increased.

The invention can be implemented in digital electronic circuitry, or in computer hardware, firmware, software, or in combinations of them. The invention can be implemented in a computer program product tangibly embodied in a machine-readable or computer readable storage device for execution by a programmable processor or computer. Computer readable storage devices may include, for example, diskettes, compact disks (CDs), DVDs, solid-state memory devices, and the like.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. An item editing device for editing a plurality of items arranged in a layout area, comprising:
an oriented item determination unit that determines for each selected item in a group of plural selected items that are selected from among the items arranged in the layout area whether the selected item is an oriented item with specific vertical and horizontal axes, or an un-oriented item without specific vertical and horizontal axes;
a batch changing unit that changes attribute information for all selected items based on the orientation of each selected item determined by the oriented item determination unit; and
an item layout unit that rearranges all selected items in the layout area based on the attribute information of the selected items after being changed by the batch changing unit.

2. The item editing device described in claim 1, wherein the batch changing unit comprises:
an orientation determination unit that determines a width-change direction and a height-change direction of each selected item based on prescribed rules when the attribute that is changed is a width or a height;
a target item attribute changing unit that changes the attribute information of a target item; and
a grouped item attribute changing unit that changes the attribute information for each grouped item based on the before and after values of the attribute information of the target item that are changed by the target item attribute changing unit,
the grouped items being the selected items other than the target item.

3. The item editing device described in claim 2, wherein when the attribute that is changed is the width or the height:
the grouped item attribute changing unit changes the attribute information of the grouped items based on the before and after attribute values, the width-change direction, and the height-change direction of the target item, and the width-change direction, the height-change direction, and the attribute information of the grouped item before the attribute information is changed.

4. The item editing device described in claim 2, wherein:
when the attribute that is changed is the width or the height, the grouped item attribute changing unit changes the attribute information of the grouped item so that after the attribute information is changed the amount of change in the attribute information of the target item is equal to the amount of change in the attribute information of the grouped item;
when the attribute that is changed is the angle of rotation or position, the grouped item attribute changing unit changes the attribute information of the grouped item so that after the attribute information is changed the amount of change in the attribute information of the target item and the amount of change in the attribute information of the grouped item are the same; and
when the attribute that is changed is a display attribute, the grouped item attribute changing unit changes the attribute information of the grouped item so that after the attribute information is changed the attribute value of the target item and the attribute value of the grouped item are the same.

5. The item editing device described in claim 2, wherein the prescribed rule is:
a positive angle α is predefined; and
when the selected item is an un-oriented item,
if the angle of rotation θ of the selected item is
0°≦θ<α, or
(180°−α)≦θ<(180°+α), or
(360°−α)≦θ<360°, and
movement of a side perpendicular to a line at an angle of rotation θ is the width-change direction of the item, and movement of a side parallel to the line at an angle of rotation θ is the height-change direction of the item, and
if the angle of rotation θ of the selected item is
α≦θ<(180°−α), or
(180°+α)≦θ<(360°−α),
movement of a side perpendicular to a line at an angle of rotation θ is the height-change direction of the item, and movement of a side parallel to the line at an angle of rotation θ is the width-change direction of the item; and
when the selected item is an oriented item, the horizontal direction when the selected item is reset to θ=0° is the width-change direction, and the vertical direction when the selected item is reset to θ=0° is the height-change direction regardless of the angle of rotation θ of the selected item.

6. An item editing method for editing a plurality of items arranged in a layout area, comprising:
(a) an oriented item determination step that determines for each selected item in a group of plural selected items that are selected from among the items arranged in the layout area whether the item is an oriented item with specific vertical and horizontal axes, or an un-oriented item without specific vertical and horizontal axes;
(b) a batch changing step that changes attribute information for all selected items based on the orientation of each selected item determined by the (a) oriented item determination step; and
(c) an item layout step that rearranges all selected items in the layout area based on the attribute information of the selected items after being changed by the (b) batch changing step.

7. The item editing method described in claim 6, wherein the (b) batch changing step comprises:
(d) an orientation determination step that determines the width-change direction and the height-change direction of each selected item based on prescribed rules when the attribute that is changed is a width or a height;
(e) a target item attribute changing step that changes the attribute information of a target item; and
(f) a grouped item attribute changing step that changes the attribute information for each grouped item based on the before and after values of the attribute information of the target item that are changed by the target item attribute changing unit,
the grouped items being the selected items other than the target item.

8. The item editing method described in claim 7, wherein when the attribute that is changed is the width or the height:
the (f) grouped item attribute changing step changes the attribute information of the grouped items based on the before and after attribute values, the width-change direction, and the height-change direction of the target item, and the width-change direction, the height-change direction, and the attribute information of the grouped item before the attribute information is changed.

9. The item editing method described in claim 7, wherein:
when the attribute that is changed is the width or the height, the (f) grouped item attribute changing step changes the attribute information of the grouped item so that after the attribute information is changed the amount of change in the attribute information of the target item is equal to the amount of change in the attribute information of the grouped item;
when the attribute that is changed is the angle of rotation or position, the (f) grouped item attribute changing step changes the attribute information of the grouped item so that after the attribute information is changed the amount of change in the attribute information of the target item and the amount of change in the attribute information of the grouped item are the same; and
when the attribute that is changed is a display attribute, the (f) grouped item attribute changing step changes the attribute information of the grouped item so that after the attribute information is changed the attribute value of the target item and the attribute value of the grouped item are the same.

10. The item editing method described in claim 7, wherein the prescribed rule is:
a positive angle α is predefined; and
when the selected item is an un-oriented item,
if the angle of rotation θ of the selected item is
0°≦θ<α, or
(180°−α)≦θ<(180°+α), or
(360°−α)≦θ<360°
movement of a side perpendicular to a line at an angle of rotation θ is the width-change direction of the item, and movement of a side parallel to the line at an angle of rotation θ is the height-change direction of the item, and
if the angle of rotation θ of the selected item is
α≦θ<(180°−α), or
(180°+α)≦θ<(360°−α),
movement of a side perpendicular to a line at an angle of rotation θ is the height-change direction of the item, and movement of a side parallel to the line at angle of rotation θ is the width-change direction of the item; and
when the selected item is an oriented item, the horizontal direction when the selected item is reset to θ=0° is the width-change direction, and the vertical direction when the selected item is reset to θ=0° is the height-change direction regardless of the angle of rotation θ of the selected item.

11. A tangible computer-readable medium embodying program instructions executable by a computer, the media including instructions for performing the item editing method of claim 6.

12. A tangible computer-readable medium embodying program instructions executable by a computer, the media including instructions for performing the item editing method of claim 7.

13. A tangible computer-readable medium embodying program instructions executable by a computer, the media including instructions for performing the item editing method of claim 8.

14. A tangible computer-readable medium embodying program instructions executable by a computer, the media including instructions for performing the item editing method of claim 9.

15. A tangible computer-readable medium embodying program instructions executable by a computer, the media including instructions for performing the item editing method of claim 10.
